(19) United States
(12) Patent Application Publication
(10) Pub. No.: US 2024/0337447 A1
(43) Pub. Date: Oct. 10, 2024

(54) BLAST FURNACE SLAG LEVEL ESTIMATION METHOD, OPERATION GUIDANCE METHOD, METHOD OF PRODUCING HOT METAL, BLAST FURNACE SLAG LEVEL ESTIMATION APPARATUS, AND OPERATION GUIDANCE APPARATUS

(71) Applicant: JFE STEEL CORPORATION, Chiyoda-ku, Tokyo (JP)

(72) Inventors: Yoshinari HASHIMOTO, Chiyoda-ku, Tokyo (JP); Ryosuke MASUDA, Chiyoda-ku, Tokyo (JP)

(73) Assignee: JFE STEEL CORPORATION, Chiyoda-ku, Tokyo (JP)

(21) Appl. No.: 18/579,405

(22) PCT Filed: Jul. 11, 2022
(86) PCT No.: PCT/JP2022/027308

§ 371 Date: Jan. 15, 2024

(30) Foreign Application Priority Data
Jul. 27, 2021 (JP) 2021-122754

(51) Int. Cl. F27D 21/00; F27D 19/00; F27D 21/02

(52) U.S. Cl. CPC F27D 21/0028; F27D 21/02; F27D 2019/0071

(57) ABSTRACT

A blast furnace slag level estimation method and blast furnace slag level estimation apparatus can estimate the liquid level of slag to a high degree of accuracy. An operation guidance method, method of producing hot metal, and operation guidance apparatus also provide guidance for the operation of a blast furnace based on a highly accurately estimated liquid level of slag. The blast furnace slag level estimation method includes a step (S2) of calculating a liquid level of melt containing slag for each region in a plurality of regions separated by a low permeability zone, using a physical model that takes at least one of hot metal tapping rate, slag tapping rate, hot metal production rate, and slag production rate as an input and that is based on a mass balance assuming existence of the low permeability zone with poor permeation of slag at a bottom of a furnace.

### TECHNICAL FIELD

The present disclosure relates to a blast furnace slag level estimation method, an operation guidance method, a method of producing hot metal, a blast furnace slag level estimation apparatus, and an operation guidance apparatus.

### BACKGROUND

In the blast furnace process of the steelmaking industry, the liquid level of slag (hereinafter referred to simply as “slag level”) is an important management indicator. Higher slag levels lead to worse gas permeability in the blast furnace. A significant degree of increase in the slag level can lead to damage to the tuyere. Factors that increase the slag level include a decrease in the void ratio of the coke packed layer at the bottom of the furnace and an increase in slag viscosity due to a decrease in the temperature at the bottom of the furnace. Operation actions to reduce the slag level include adjusting the basicity (CaO/SiO₂) of the burden to reduce the viscosity of the slag and reducing the slag formation rate through wind reduction.

Many methods have been proposed to measure or estimate the slag level. For example, Patent Literature (PTL) 1 discloses a measurement method for installing a plurality of measurement electrode groups arrayed in the height direction around the perimeter of a furnace and measuring the melt level in the furnace near the installation position of each measurement electrode group based on the electrical resistance.

### CITATION LIST

### Patent Literature

PTL 1: JP 5412819 B2

### SUMMARY

### Technical Problem

Here, it is known that local differences in the slag level can occur. Deterioration of gas permeability in the furnace and the threat of damage to the tuyere can also be caused by a locally elevated slag level. In addition, in modern large-scale blast furnaces (for example, 5000 m³ class), the non-uniformity of the liquid level has become more pronounced as the cross-sectional area of the furnace has expanded. The non-uniform liquid level of slag is therefore preferably taken into consideration in order to achieve stable operation of the blast furnace process.

For example, the technique in PTL 1 can accurately measure the liquid level, but the measurement is limited to the liquid level near the furnace wall. Another conventional estimation method is to calculate the slag level based on the mass balance, but this method only estimates the average slag level in a furnace cross-section, making it difficult to estimate local changes.

It could be helpful to provide a blast furnace slag level estimation method and a blast furnace slag level estimation apparatus that can estimate the liquid level of slag to a high degree of accuracy. It could also be helpful to provide an operation guidance method, a method of producing hot metal, and an operation guidance apparatus that provide guidance for the operation of a blast furnace based on a highly accurately estimated liquid level of slag.

### Solution to Problem

A blast furnace slag level estimation method according to an embodiment of the present disclosure includes:
calculating a liquid level of melt containing slag for each region in a plurality of regions separated by a low permeability zone, using a physical model that takes at least one of hot metal tapping rate, slag tapping rate, hot metal production rate, and slag production rate as an input and that is based on a mass balance assuming existence of the low permeability zone with poor permeation of slag at a bottom of a furnace.

An operation guidance method according to an embodiment of the present disclosure includes:
presenting an operation action to an operator to reduce permeability resistance based on the liquid level of melt calculated by the aforementioned blast furnace slag level estimation method.

A method of producing hot metal according to an embodiment of the present disclosure includes:
producing hot metal in accordance with the operation action presented by the aforementioned operation guidance method.

A blast furnace slag level estimation apparatus according to an embodiment of the present disclosure includes:
a memory configured to store a physical model that takes at least one of hot metal tapping rate, slag tapping rate, hot metal production rate, and slag production rate as an input and that is based on a mass balance assuming existence of a low permeability zone with poor permeation of slag at a bottom of a furnace; and
a liquid level calculator configured to calculate a liquid level of melt containing slag for each region in a plurality of regions separated by the low permeability zone, using the physical model.

An operation guidance apparatus according to an embodiment of the present disclosure includes:
an operation action presentation interface configured to present an operation action to an operator to reduce permeability resistance based on the liquid level of melt calculated by the aforementioned blast furnace slag level estimation apparatus.

### Advantageous Effect

According to the present disclosure, a blast furnace slag level estimation method and a blast furnace slag level estimation apparatus that can estimate the liquid level of slag to a high degree of accuracy can be provided. According to the present disclosure, an operation guidance method, a method of producing hot metal, and an operation guidance apparatus that provide guidance for the operation of a blast furnace based on a highly accurately estimated liquid level of slag can also be provided.

### BRIEF DESCRIPTION OF THE DRAWINGS

In the accompanying drawings:

FIG. 1 is a diagram illustrating input/output information of a physical model used in the present disclosure;

FIG. 2 is a diagram illustrating a configuration of a blast furnace;

FIG. 3 is a diagram illustrating the correlation with taphole deviation in an actual blast furnace;

FIG. 4 is a diagram illustrating one result of a simulation using a physical model;

FIG. 5 is a diagram illustrating the result of a comparison between the correlation using the physical model and the correlation for actual data;

FIG. 6 is a diagram illustrating the relationship between the area ratio of a plurality of regions and the Δslag amount;

FIG. 7 is a diagram illustrating one result of a simulation using a physical model that reflects the position of the daily low permeability zone;

FIG. 8 is a diagram illustrating the correlation between permeability resistance and slag level;

FIG. 9 is a diagram illustrating example configurations of a blast furnace slag level estimation apparatus and an operation guidance apparatus according to an embodiment;

FIG. 10 is a flowchart illustrating a blast furnace slag level estimation method according to an embodiment; and

FIG. 11 is a flowchart illustrating an operation guidance method according to an embodiment.

### DETAILED DESCRIPTION

A blast furnace slag level estimation method, an operation guidance method, a method of producing hot metal, a blast furnace slag level estimation apparatus, and an operation guidance apparatus according to an embodiment of the present disclosure are described below with reference to the drawings. The physical model used in the present disclosure is a physical model that can calculate the state inside a blast furnace. The physical model used in the present disclosure is a model that assumes the existence of a low permeability zone (low permeability region) at the bottom of the furnace, similar to the method described in Reference 1 (SAWA Yoshitaka et al., “Influence of Low Permeability Zone in Blast Furnace Hearth on Temperature Distribution in Furnace Bottom and on Iron and Slag Tapping Indices”, Tetsu-to-Hagane, vol. 78, p. 1171).

Here, the low permeability zone is a region in which the void ratio in the coke packed layer at the bottom of the furnace is reduced, and in which the liquid permeability is extremely deteriorated. In modern large-scale blast furnaces, the region at the furnace bottom is divided by a low permeability zone. This is thought to allow low-viscosity hot metal to permeate, while nearly preventing slag from permeating. Although the low permeability zone cannot be directly observed, the low permeability zone is thought to exist in large-scale blast furnaces in which the liquid level exhibits non-uniformity.

The physical model used in the present disclosure first defines the position of the low permeability zone and then, provided an input, outputs the liquid level of melt in each region divided by the low permeability zone.

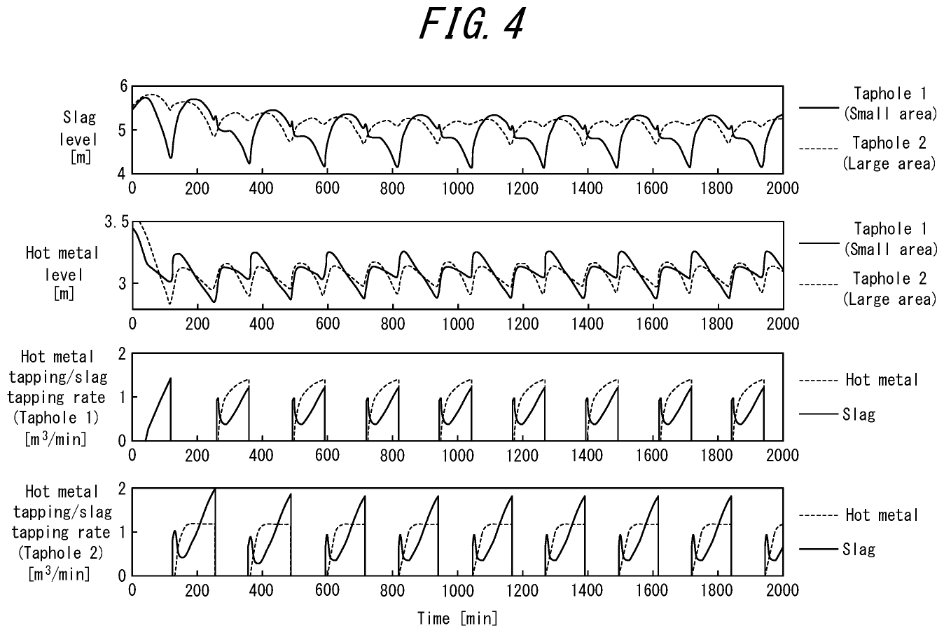

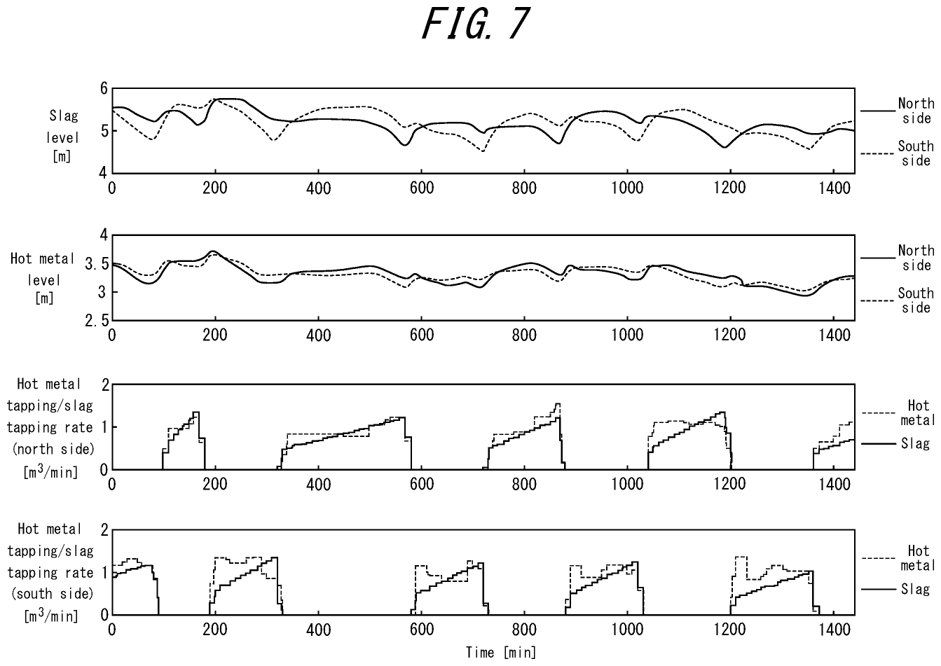

Here, it suffices for the physical model to output at least the slag level for each region divided by the low permeability zone. It suffices for the physical model to acquire at least one of hot metal tapping rate, slag tapping rate, hot metal production rate, and slag production rate as an input. The actual inputs and outputs are changed depending on the intended use of the physical model. For example, opening and closing of the taphole, hot metal production rate, and slag production rate may be inputs, and the hot metal tapping rate, slag tapping rate, and liquid level may be outputs (for example, see FIG. 4). Not only the opening and closing of the taphole, but also the hot metal production rate and slag production rate can be inputted as actual measurements to obtain the liquid level as output (for example, see FIG. 7).

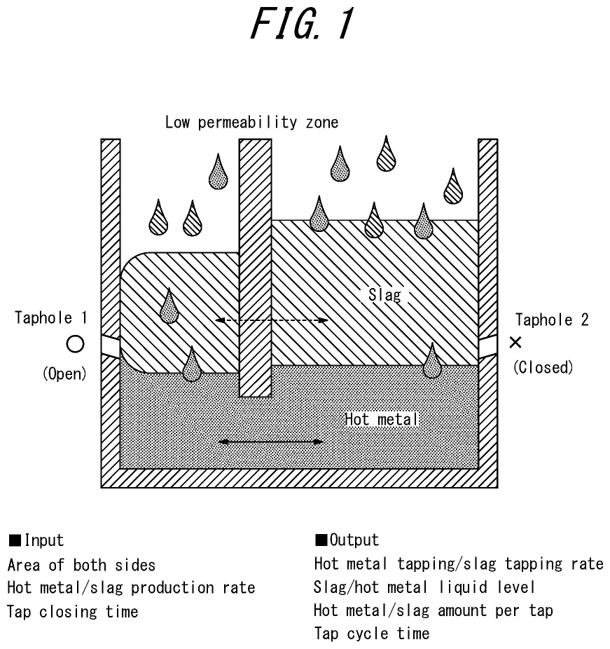

As illustrated in FIG. 1, a variety of data may be used as input and output for the physical model that calculates the state inside the furnace. In an embodiment, the area of both sides, the hot metal/slag production rate (hot metal production rate and slag production rate), and the tap closing time (closing time of taphole) are inputted to the physical model. In an embodiment, the physical model outputs the hot metal tapping/slag tapping rate (hot metal tapping rate and slag tapping rate), slag/hot metal liquid level (slag liquid level and hot metal liquid level), hot metal/slag amount per tap (hot metal amount and slag amount), and tap cycle time. Here, the two sides are the two regions divided by the low permeability zone, as illustrated in FIG. 1. Each of the two regions has a taphole, and the blast furnace process is conducted so that when one is open, the other is closed. A tap refers to tapping or to a taphole. In the physical model, it is determined to close at the point when the high liquid level immediately after tapping gradually decreases to the same height as the taphole, and the tap cycle time is calculated based on this determination.

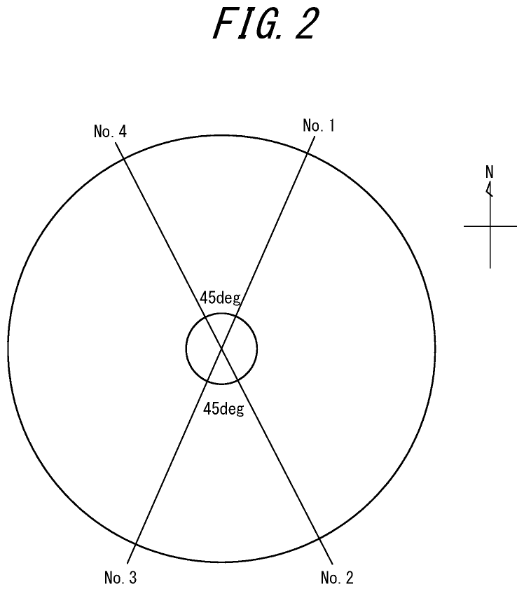

In the present embodiment, the blast furnace is a large-scale blast furnace (for example, 5000 m³ class with a radius of 9000 mm) and has four tapholes, as illustrated in FIG. 2. Here, the number of tapholes in the blast furnace is not limited to four and need only be two or more. In the present embodiment, the tapholes are divided into two groups: two tapholes on the south side (No. 2 and No. 3), and two tapholes on the north side (No. 1 and No. 4). In the operation of the blast furnace, the south and north tapholes are used alternately, as described above. In the present embodiment, the slag levels in the south and north regions are estimated assuming the existence of a low permeability zone between the south and north regions.

Upon investigating ways to estimate the slag level including local differences, we discovered that estimation to a high degree of accuracy is possible by assuming the existence of a low permeability zone and providing the position of the low permeability zone to the physical model. More specifically, by focusing on deviations in factors such as the slag amount at each taphole (hereinafter also referred to as tap deviation) and determining the position of the low permeability zone to reproduce the tap deviation in an actual blast furnace by the method described below, a highly accurate estimation (calculation) of the slag level can be made.

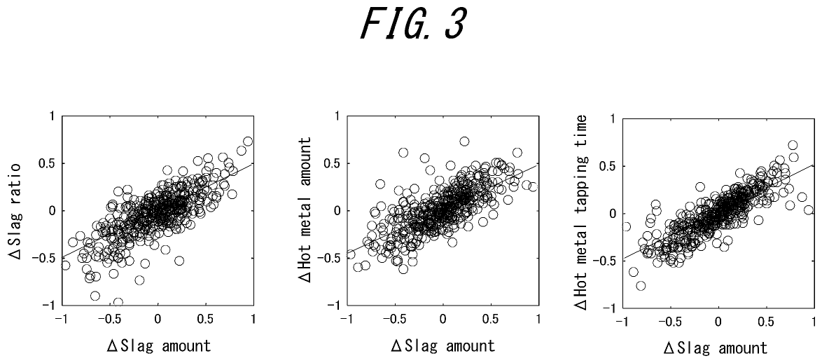

FIG. 3 is a diagram illustrating the correlation with taphole deviation in an actual blast furnace. The Δslag amount on the horizontal axis in FIG. 3 indicates the taphole deviation (region deviation) in the slag tapping amount. In other words, the Δslag amount indicates the difference in the slag tapping amount in each region in the plurality of regions. The deviation is calculated based on the value yielded by subtracting the south side (No. 2 and No. 3) from the north side (No. 1 and No. 4). In other words, the Δslag amount is determined using the value yielded by subtracting the slag tapping amount on the south side from the slag tapping amount on the north side. Similarly, the Δslag ratio, Δhot metal amount, and Δhot metal tapping time on the vertical axis in FIG. 3 are calculated based on the value yielded by subtracting the south side from the north side for the slag ratio, hot metal amount, and hot metal tapping time. The slag ratio is the ratio of the slag amount to the hot metal amount, expressed as the amount of slag per tonne of hot metal. One point plotted in FIG. 3 corresponds to the average for one day. In each figure, standardization was also performed using the average of the values for the north and south sides. For example, the Δslag amount is calculated as (north slag tapping amount−south slag tapping amount)/((north slag tapping amount+south slag tapping amount)/2). On the side with a high slag tapping amount, there is a strong tendency for a higher tapping amount, higher slag ratio, and longer hot metal tapping time.

The aforementioned correlation with the taphole deviation can be explained by assuming the existence of a low permeability zone. To explain with the example in FIG. 1, more slag needs to be discharged on the side with the larger area (the side with taphole 2) in the plurality of regions separated by the low permeability zone. The volume of hot metal tapping and slag tapping increases, which also extends the time required until closing on the side with taphole 2. In addition, the hot metal amount is higher at taphole 2, which is the side with the larger area. Furthermore, the low permeability zone is impermeable for slag but is highly permeable for hot metal. Therefore, the slag ratio is higher on the side with taphole 2, since the taphole deviation for the slag amount is larger than the taphole deviation for the hot metal amount.

Next, simulations were performed using the aforementioned physical model to verify the possibility of a quantitative explanation for the taphole deviation in an actual blast furnace. FIG. 4 illustrates the result of a simulation performed under the average operating conditions for the operation period illustrated in FIG. 3 using the physical model (with typical values of the hot metal production rate and slag production rate as inputs). In this simulation, the tap closing time is provided, and the slag amount and hot metal amount in each tap are calculated by estimation. In other words, the hot metal tapping rate and slag tapping rate are calculated as outputs of the physical model. In this simulation, it is assumed that the low permeability zone divides the side by taphole 1 (north side) from the side by taphole 2 (south side) in a ratio of 2:8 in terms of the cross-sectional area ratio inside the furnace. It is clear that on the taphole 2 side, which has a larger area, the slag amount is higher and the time from the start to the end of tapping is longer (in particular, see the hot metal tapping/slag tapping rate (taphole 2) in FIG. 4).

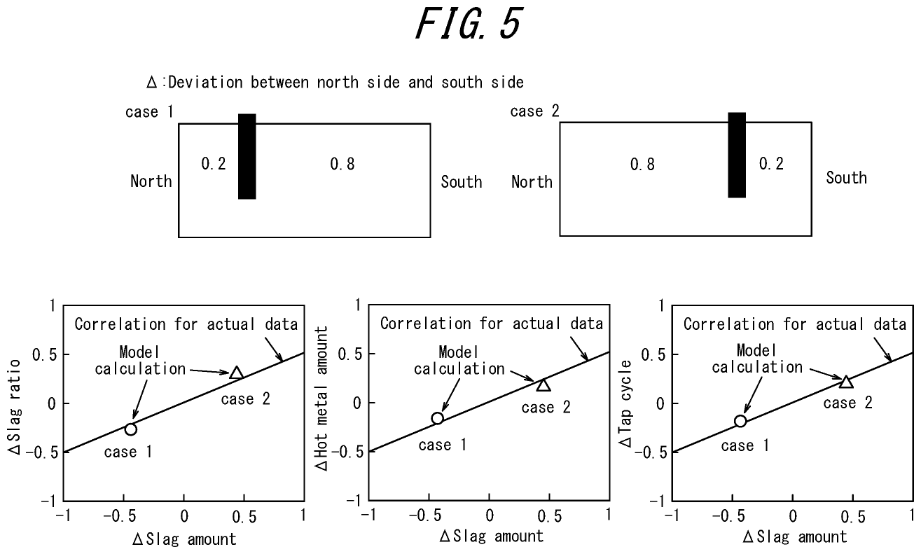

Such a simulation was performed by varying the position of the low permeability zone, yielding results, as illustrated in FIG. 5, for which the slope (correlation) nearly matched data from an actual blast furnace regarding the correlation with taphole deviation for the slag ratio, hot metal amount, and tap cycle versus the slag amount. The simulation was performed by varying the position of the low permeability zone to include case 1 and case 2 illustrated in FIG. 5. As in FIG. 4, case 1 is the case in which the low permeability zone divides the north side and south side in a 2:8 ratio. Case 2 is the case in which the low permeability zone divides the north side and south side in an 8:2 ratio. It is thus clear that by varying the position of the low permeability zone in the simulation using the physical model, the taphole deviation can be quantitatively reproduced.

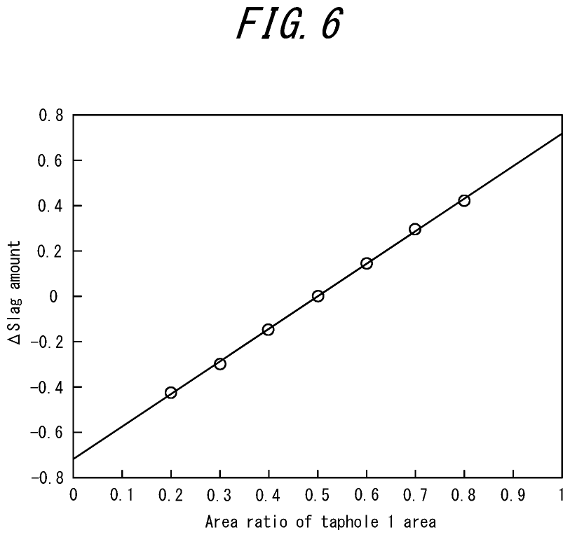

Based on the relationship, obtained as described above, between the taphole deviation in the slag amount and the position of the low permeability zone, a method for estimating the position of the low permeability zone in an actual blast furnace was studied. As illustrated in FIG. 6, upon changing the area ratio due to the low permeability zone from 0.2 to 0.8, the taphole deviation in the slag amount changes almost linearly from −0.42 to 0.42. Using this linear relationship, the position of the low permeability zone was estimated based on the deviation in the slag amount (Δslag amount) for the most recent predetermined period during operation of the blast furnace. In the present embodiment, the predetermined period is one day. In other words, using this linear relationship, the position of the low permeability zone on each day is estimated based on the Δslag amount over the past day.

Using the daily position of the low permeability zone estimated in this way, the slag level and hot metal liquid level were estimated (calculated) by the aforementioned physical model. After providing the estimated position of the low permeability zone, the hot metal tapping rate, slag tapping rate, hot metal production rate, and slag production rate, which vary over time, were inputted to the physical model. In other words, the position of the low permeability zone was updated daily, and using this position of the low permeability zone, the hot metal tapping rate, slag tapping rate, hot metal production rate, and slag production rate, which vary over a shorter time (such as 1 hour), were inputted to the physical model. The hot metal production rate and slag production rate in an actual blast furnace can be determined by multiplying the number of material layers dropped per hour (ch/hour) by the hot metal amount (t/ch) and slag amount (t/ch) contained in 1 charge (ch). The hot metal tapping rate and slag tapping rate can be determined by linear interpolation based on the data for each hot metal tapping cycle. FIG. 7 illustrates the result of determining the position of the low permeability zone each day and estimating (calculating) the liquid level on the north side and south side using a physical model that reflects this position.

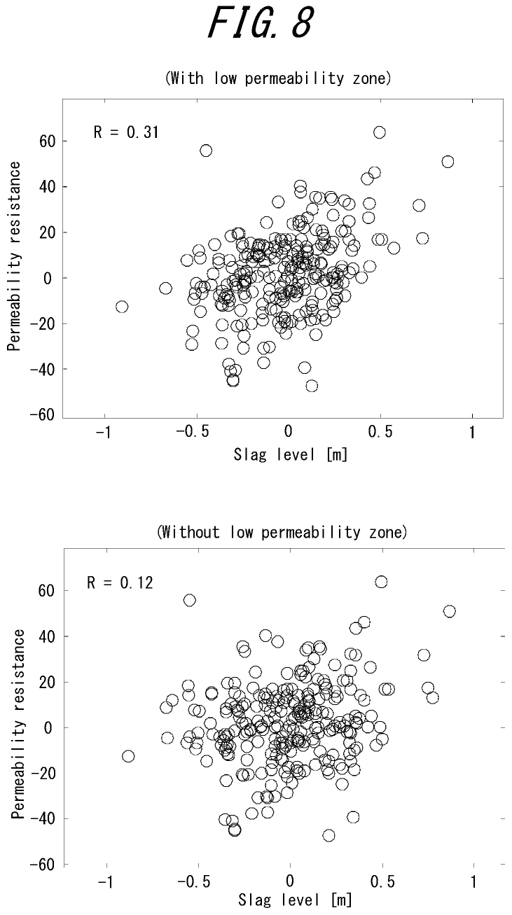

Furthermore, the liquid level estimated in this way was compared between the north side and south side, and the higher value was selected as the maximum slag level. A comparison between the maximum slag level and the permeability resistance of the furnace gas in the actual blast furnace yielded a correlation as illustrated in the graph labeled “with low permeability zone” in FIG. 8. The slag level on the horizontal axis indicates the maximum slag level. R is the correlation coefficient. Here, the permeability resistance increases as the slag level increases. Therefore, the high correlation between permeability resistance and slag level means that the estimated slag level is highly accurate.

The graph labeled “without low permeability zone” in FIG. 8 is the correlation obtained with a conventional technique that does not assume the existence of a low permeability zone. As is clear from a comparison to “without low permeability zone”, the method of the present embodiment that estimates the position assuming the existence of a low permeability zone yields a higher correlation, and the accuracy of the estimated slag level is improved compared to a conventional technique.

A blast furnace slag level estimation apparatus according to the present embodiment (see below for details) can estimate the liquid level of slag to a high degree of accuracy by estimating the position assuming the existence of a low permeability zone as described above and using a physical model that reflects this position.

An operation guidance apparatus according to the present embodiment (see below for details) can provide guidance to reduce the slag level in a case in which the estimated slag level exceeds a threshold. The threshold is not particularly limited but may, for example, be set at 0.5 m below the tuyere height. The guidance may be the presentation of an operation action, such as adjusting the basicity (CaO/SiO₂) of the burden to reduce the viscosity of the slag or reducing the slag formation rate through wind reduction. The operation guidance apparatus can avoid operational problems (such as damage to the tuyere) by presenting appropriate operation actions to the operator.

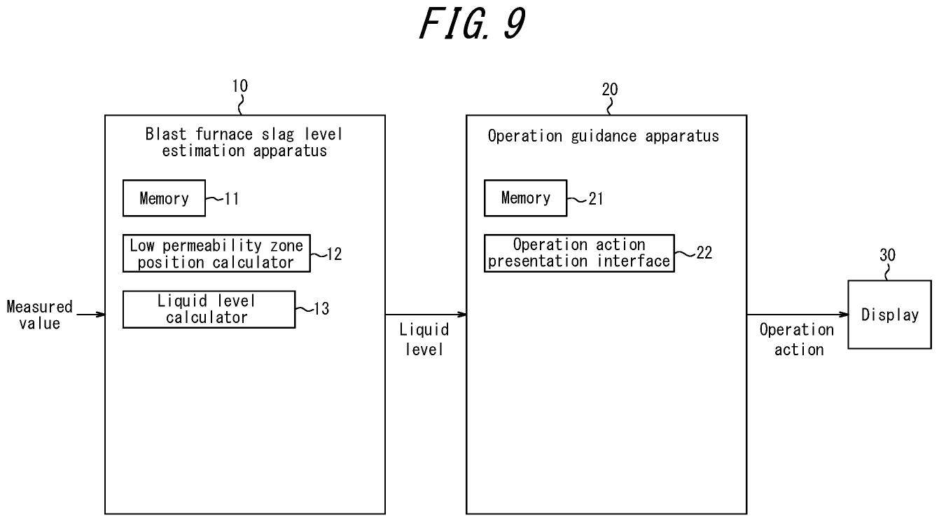

FIG. 9 is a diagram illustrating example configurations of a blast furnace slag level estimation apparatus 10 and an operation guidance apparatus 20 according to an embodiment. As illustrated in FIG. 9, the blast furnace slag level estimation apparatus 10 includes a memory 11, a low permeability zone position calculator 12, and a liquid level calculator 13. The operation guidance apparatus 20 includes a memory 21 and an operation action presentation interface 22. The blast furnace slag level estimation apparatus 10 acquires various performance values (also referred to as measured values) from sensors and the like installed in the blast furnace, estimates the position assuming the existence of a low permeability zone, and performs calculations using the aforementioned physical model with the position reflected therein. The operation guidance apparatus 20 displays an operation action as guidance on a display 30 in a case in which the estimated slag level exceeds a threshold. The display 30 may be a display device such as a liquid crystal display (LCD) or an organic electro-luminescent (EL) panel.

First, the components of the blast furnace slag level estimation apparatus 10 are described. The memory 11 stores a physical model based on a mass balance assuming existence of the low permeability zone with poor permeation of slag at the bottom of the furnace. The memory 11 stores programs and data related to the calculation of the liquid level of melt containing slag in the blast furnace. The memory 11 may include any memory device, such as semiconductor memory devices, optical memory devices, and magnetic memory devices. Semiconductor memory devices may, for example, include semiconductor memories. The memory 11 may include a plurality of types of memory devices.

The low permeability zone position calculator 12 calculates the position of the low permeability zone based on the Δslag amount for the most recent predetermined period using the relationship (see FIG. 6) between the area ratio of the plurality of regions and the Δslag amount, which is the difference in the slag tapping amount in each region in the plurality of regions. In the present embodiment, the relationship between the area ratio of the plurality of regions and the Δslag amount is a linear relationship as described above, and an equation or the like indicating this linear relationship may be stored in the memory 11. The low permeability zone position calculator 12 may read a relational equation, for example, from the memory 11 and predict (calculate) the position of the low permeability zone based on the Δslag amount for the most recent predetermined period. In the present embodiment, the predetermined period is 1 day, as described above, and the daily position of the low permeability zone is estimated by the low permeability zone position calculator 12. Here, the predetermined period is not limited to 1 day and may be longer or shorter than 1 day.

The liquid level calculator 13 uses the physical model to calculate the liquid level of melt for each region in the plurality of regions separated by the low permeability zone, taking at least one of hot metal tapping rate, slag tapping rate, hot metal production rate, and slag production rate as an input. The physical model is a model that reflects the position of the low permeability zone calculated by the low permeability zone position calculator 12. In the present embodiment, the liquid level of melt includes the liquid level of slag and the liquid level of hot metal. The liquid level calculator 13 outputs the calculated liquid level of melt to the operation guidance apparatus 20.

Next, the components of the operation guidance apparatus 20 are described. The memory 21 stores programs and data related to operation guidance. The memory 21 may include any memory device, such as semiconductor memory devices, optical memory devices, and magnetic memory devices. Semiconductor memory devices may, for example, include semiconductor memories. The memory 21 may include a plurality of types of memory devices.

The operation action presentation interface 22 determines whether the estimated slag level exceeds a threshold based on the liquid level of melt calculated by the blast furnace slag level estimation apparatus 10. In a case in which the slag level is determined to exceed the threshold, the operation action presentation interface 22 causes the display 30 to display an operation action to lower the slag level. The operation action presentation interface 22 may, for example, display a reduction in the slag formation rate through wind reduction as the operation action on the display 30.

The operator may change the operating conditions of the blast furnace according to the operation action displayed on the display 30. Such operation guidance for the blast furnace can be implemented as part of a method of producing hot metal. Furthermore, the computer that manages the production of hot metal may automatically change the conditions for the production of hot metal according to the operation action presented by the operation guidance apparatus 20.

Here, the blast furnace slag level estimation apparatus 10 and the operation guidance apparatus 20 may be separate apparatuses or integrated into one apparatus. In the case of an integrated apparatus, the memory 11 and the memory 21 may be realized by the same memory device.

The blast furnace slag level estimation apparatus 10 and the operation guidance apparatus 20 may be realized by a computer, such as a process computer that controls the operation of a blast furnace or the production of hot metal, for example. The computer includes, for example, a memory and hard disk drive (memory device), a CPU (processing unit), and a display device such as a display. An operating system (OS) and application programs for carrying out various processes can be stored on the hard disk drive and are read from the hard disk drive into memory when executed by the CPU. Data during processing is stored in memory, and if necessary, on the HDD. Various functions are realized through the organic collaboration of hardware (such as the CPU and memory), the OS, and necessary application programs. The memory 11 and the memory 21 may, for example, be realized by a memory device. The low permeability zone position calculator 12, the liquid level calculator 13, and the operation action presentation interface 22 may, for example, be realized by the CPU. The display 30 may, for example, be realized by a display device.

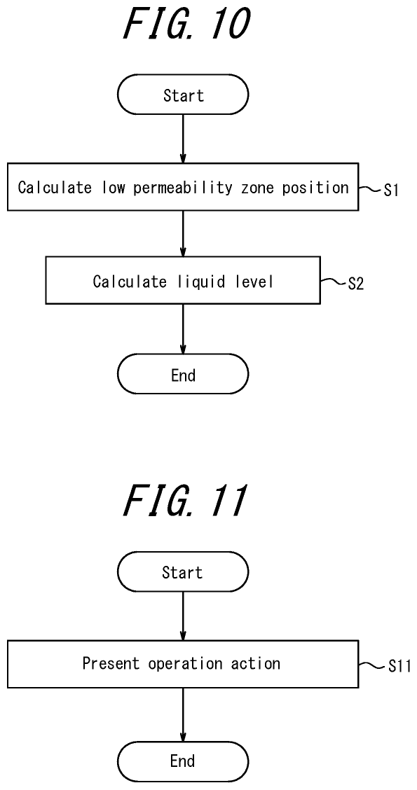

FIG. 10 is a flowchart illustrating a blast furnace slag level estimation method according to an embodiment. The blast furnace slag level estimation apparatus 10 outputs the estimated liquid level according to the flowchart illustrated in FIG. 10. The blast furnace slag level estimation method illustrated in FIG. 10 may be performed as part of a method of producing hot metal.

The low permeability zone position calculator 12 calculates the low permeability zone position based on the Δslag amount for the most recent predetermined period (step S1). The liquid level calculator 13 calculates a liquid level of melt containing slag for each region in a plurality of regions separated by the low permeability zone, using the physical model that reflects the position of the low permeability zone calculated in step S1 (step S2). As illustrated in FIG. 10, the step to calculate the position of the low permeability zone is performed before the step to calculate the liquid level of melt. Step S1 may, for example, be performed once a day (daily estimation of the position of the low permeability zone), and step S2 may be performed repeatedly each day. For example, the hot metal tapping rate, slag tapping rate, hot metal production rate, and slag production rate inputted to the physical model may be measured or calculated every 10 minutes, and step S2 may be performed every 10 minutes.

FIG. 11 is a flowchart illustrating an operation guidance method according to an embodiment. The operation guidance apparatus 20 presents an operation action according to the flowchart illustrated in FIG. 11. The operation guidance method illustrated in FIG. 11 may be performed as part of a method of producing hot metal.

In a case in which the slag level is determined to exceed the threshold based on the calculated liquid level of melt, the operation action presentation interface 22 presents an operation action to lower the slag level (step S11).

As described above, the blast furnace slag level estimation method and blast furnace slag level estimation apparatus 10 according to the present embodiment can estimate the liquid level of slag to a high degree of accuracy with the aforementioned configuration. The operation guidance method, the method of producing hot metal, and the operation guidance apparatus 20 according to the present embodiment can provide guidance for the operation of a blast furnace based on a highly accurately estimated liquid level of slag. For example, operators can avoid operational problems (such as damage to the tuyere) by following the operation action presented as guidance.

While embodiments of the present disclosure have been described based on the drawings and examples, it should be noted that various changes and modifications may be made by those skilled in the art based on the present disclosure. Accordingly, such changes and modifications are included within the scope of the present disclosure. For example, the functions and the like included in each component, step, or the like can be rearranged in a logically consistent manner. Components, steps, or the like may also be combined into one or divided. An embodiment of the present disclosure may also be implemented as a program executed by a processor provided in an apparatus or as a storage medium with the program recorded thereon. These are also encompassed within the scope of the present disclosure.

The configurations of the blast furnace slag level estimation apparatus 10 and the operation guidance apparatus 20 illustrated in FIG. 9 are only examples. The blast furnace slag level estimation apparatus 10 and the operation guidance apparatus 20 need not include all of the components illustrated in FIG. 9. The blast furnace slag level estimation apparatus 10 and the operation guidance apparatus 20 may include components other than those illustrated in FIG. 9. For example, the operation guidance apparatus 20 may further include the display 30.

In the above embodiment, the operation action presentation interface 22 of the operation guidance apparatus 20 displays the operation action on the display 30 in a case in which it is determined that the slag level exceeds a threshold. As another example, the operation action presentation interface 22 may display the operation action on the display 30 even if the slag level does not exceed the threshold and may then change the content of the operation action to an operation action that reduces the slag level in a case in which the slag level exceeds the threshold. For example, in a case in which the slag level does not exceed the threshold, the operation action presentation interface 22 may display on the display 30 an operation action indicating that no wind reduction is required and that operations may proceed at the current settings.

### REFERENCE SIGNS LIST

10 Blast furnace slag level estimation apparatus
11 Memory
12 Low permeability zone position calculator
13 Liquid level calculator
20 Operation guidance apparatus
21 Memory
22 Operation action presentation interface
30 Display

1. A blast furnace slag level estimation method comprising calculating a liquid level of melt containing slag for each region in a plurality of regions separated by a low permeability zone, using a physical model that takes at least one of hot metal tapping rate, slag tapping rate, hot metal production rate, and slag production rate as an input and that is based on a mass balance assuming existence of the low permeability zone with poor permeation of slag at a bottom of a furnace.

2. The blast furnace slag level estimation method according to claim 1, wherein the liquid level of melt includes a liquid level of slag and a liquid level of hot metal.

3. The blast furnace slag level estimation method according to claim 1, further comprising
calculating a position of the low permeability zone based on a Δslag amount for a most recent predetermined period, using a relationship between an area ratio of the plurality of regions and the Δslag amount, the Δslag amount being a difference in a slag tapping amount in each region in the plurality of regions,
wherein the calculating of the position of the low permeability zone is performed before the calculating of the liquid level of melt.

4. An operation guidance method comprising presenting an operation action to an operator to reduce permeability resistance based on the liquid level of melt calculated by the blast furnace slag level estimation method according to claim 1.

5. A method of producing hot metal, the method comprising producing hot metal in accordance with the operation action presented by the operation guidance method according to claim 4.

6. A blast furnace slag level estimation apparatus comprising:
a memory configured to store a physical model that takes at least one of hot metal tapping rate, slag tapping rate, hot metal production rate, and slag production rate as an input and that is based on a mass balance assuming existence of a low permeability zone with poor permeation of slag at a bottom of a furnace; and
a liquid level calculator configured to calculate a liquid level of melt containing slag for each region in a plurality of regions separated by the low permeability zone, using the physical model.

7. An operation guidance apparatus comprising an operation action presentation interface configured to present an operation action to an operator to reduce permeability resistance based on the liquid level of melt calculated by the blast furnace slag level estimation apparatus according to claim 6.
